(19) United States
(12) Patent Application Publication
(10) Pub. No.: US 2004/0083858 A1
(43) Pub. Date: May 6, 2004

(54) 1/4 Inch 3/8 inch drive extendable ratchet wrench

(76) Inventor: Thomas Carnesi, Torrance, CA (US)

Correspondence Address: THOMAS CARNESI, 1309 MANUEL AVENUE, TORRANCE, CA, 90501, US

(21) Appl. No.: 10/373,009

(22) Filed: Feb. 24, 2003

Related U.S. Application Data
(60) Provisional application No. 60/369,484, filed on Apr. 3, 2002.

(51) Int. Cl. B25B 13/46

(52) U.S. Cl. 81/63

(57) ABSTRACT

The ratchet wrench includes a ¼ inch and a ⅜ inch driver combination on opposite sides of the ratchet embodiment and a handle that extends to a plurality of lengths for various torque requirements. Each adjusted length is secured by a spring induced detent ball housed within a vertical hole on the ratchet's solid arm, the detent ball seats into a plurality of holes on the extendable handle. The smaller ¼ inch driver side is housed within the ratchet head and into a hollow ¼ inch square configured slot provided at the central axis of the ratcheting gear and fixed ⅜ inch driver unit. A manually slideable gate expels and retracts the spring induced ¼ inch driver outward to an adequate working length and is manually retracted and retained by the slideable gate. The ratchet has an ultra thin profile for use in limited working spaces and convenient storage.

### CLASS 81/177 REFERENCES CITED

U.S. Patent Documents:

| | | | |
|---|---|---|---|
| 1018080 | February 1912 | Reston | 81/60. |
| 1371350 | March 1921 | Campbell | |
| 1578065 | March 1926 | Bemus et al. | |
| 1626906 | May 1927 | Zilliox | |
| 1769070 | July 1930 | Nowosielski | |
| 2636411 | April 1953 | Wood | 81/60. |
| 2757564 | August 1956 | Reaves | 81/61. |
| 2897437 | July 1959 | Briggs et al. | |
| 2982160 | May 1961 | Little | |
| 3039340 | June 1962 | Livermont | |
| 3505714 | April 1970 | Boileau | |
| 3572188 | March 1971 | Christian, Jr. | |
| 4278314 | July 1981 | Taub | |
| 4324158 | April 1982 | Le Roy | |
| 4441387 | April 1984 | Hsidericks | 81/61. |
| 4480511 | November 1984 | Nickipuck | |
| 4703636 | November 1987 | Mayer | 81/60. |
| 4748874 | June 1988 | Sharp et al. | |
| 4768405 | September 1988 | Nickipuck | |
| 4791837 | December 1988 | Main | |
| 4825732 | May 1989 | Arnold | |
| 4905549 | March 1990 | Nickipuck | |
| 4938107 | July 1990 | Nickipuck | |
| 5005448 | April 1991 | Main | 81/63. |
| 5289745 | March 1994 | Beardsley | |
| 5291809 | March 1994 | Fox, III et al. | |
| 5901620 | May 1999 | Arnold | 81/60. |
| 6009777 | January 2000 | Jarvis | |
| 6263766 | July 2001 | Jarvis | 81/60. |
| 6516689 | February 2003 | Bates | 81/60. |

Prior art (application No. 60/369,484) in part relates to the subject matter of this ¼ inch/⅜ inch drive extendable ratchet design with the exception of modifications made to enhance the overall performance and design elements of the invention as explicitly expressed in this preferred embodiment herein.

### BACKGROUND OF THE INVENTION

This utility patent application is for an extendable ratchet that provides both a ¼ inch and a ⅜ inch universal driver for both ¼ inch and ⅜ inch driven sockets, and an extendable handle having a plurality of leverage for various torque requirements.

### SUMMARY OF THE INVENTION

The object of this invention is to provide a ratchet wrench having both a ¼ inch and a ⅜ inch universal driver combination on opposite sides for wrenching both a ¼ inch and a ⅜ inch standard drive sockets. The ratchet also has a slideable handle that adjusts to a plurality of lengths for required torque needs. This invention has several beneficial features that include but are not limited to: convenience of use; compactness when stowed with the extendable handle fully retracted and a combination ¼ inch extendable driver on one side of the ratchet head and a fixed ⅜ inch driver on the opposite side of the head. This eliminates the need for two individual size ratchet wrenches and an extendable handle that adjusts to a plurality of lengths for various torque needs. As the larger ⅜ inch driver side is being used, the ¼ inch slideable driver side can simultaneously be extended or retracted within the central axis of the ratchet head and into the ratchet gear and ⅜ inch driver side. When the use for the smaller ¼ driver side is required, the user simply compresses the slideable release gate inwards. This causes the ¼ inch driver side to expel automatically with the aid of a spring bias seated between the interior upper end of the ¼ inch male square driver and the interior of the ¼ female square slot located within the central axis of the ratchet gear and the ⅜ inch square fixed driver. To retract the smaller ¼ driver end when it is not in use, the user compresses the knurled thumb surface of the slideable gate inwards to release the ¼ inch driver side until it is retained by both the slideable retainer gate within the slideable gate's central hole diameter and by its smaller and extending elongated slot diameter. The smaller elongated slot interlocks with the retaining and retracting grooves of the ¼ driver end.

The ratchet's overall length, when fully extended, is approximately 7.00 inches, 6.00 inches at intermediate adjustment and 5.00 inches when fully retracted. Each extendable length is secured by a spring loaded steel detent ball that seats into three holes which are equally spaced approximately 1.00 inch apart. The steel detent ball and spring bias are nestled within a hole located at the ratchet arm. The spring bias provides a constant tension on the steel detent ball which induces tension and retains the adjusted settings at every extendable length. The ¼ and ⅜ inch drive extendable ratchet includes a housing and an extending arm, as well as a slideable handle that is hollowed to slip over the extending arm of the ratchet for adjusting the ratchet to a plurality of lengths for required torque needs. The ratchet gear includes a fixed ⅜ inch square universal driver on one side, and an interior ¼ square slot to accept a ¼ square male driver end that is slideable within that ¼ inch square hollow slot located within the central Z axis of the ratchet gear and ⅜ square driver unit. A release gate that is slideable within a channel located at the underside of the ratchet head retains the ¼ inch driver when not in use and releases it when needed. A ratcheting pawl, pivoting pin, detent ball, detent ball tension spring, pawl lever-exterior thumb piece, ratchet housing assembly cover and snap-ring for retain the ratchet components. The ratchet gear of the present invention seats and rotates in a clockwise or counterclockwise reciprocal motion within the counter bore diameter of the ratchet head. The ¼ inch driver's extendable distance is controlled by a slotted guide element located at one vertical and exterior side of the ⅜ inch driver side. The function of the guide element is to permanently retain the ¼ inch male driver end when extended for use to prevent the possibility of it from becoming expelled completely out from the ratchet embodiment. The pawl nestles within the ratchet head pocket, aft of the ratcheting gear and forward of the ratchet arm. The pawl's exterior lever thumb piece is of a reciprocal lever type and can be either clicked in a forward or reverse direction that pivots on a vertical pivot shaft, part of the ratchet pawl body. The ratchet pawl is vertically located and aligned coaxially between the lower pocket wall of the ratchet head and the top cover plate. The ratchet pawl locks the ratcheting gear in either a clockwise or a counterclockwise direction, depending upon which rotatable direction the ratcheting gear is locked in. This function is accomplished with the aid of a spring biased detent ball located at the aft area of the ratchet head pocket and forward of the extending arm. The extending arm is fitted with a vertical hole that seats a spring bias and a detent steel ball which seats within any of the three equally spaced holes on the top side of the extendable handle to lock the adjustable extensions to either a retracted 5.00 inches, 6.00 inches intermediate or fully extended 7.00 inches for higher torque requirements. The extendable handle, being of a hollow structure, slides onto the solid arm feature of the ratchet housing and is secured by a roll pin that rides within the slotted channel. This channel extends longitudinally and is parallel to and located on the underside of the solid arm feature. This allows the roll pin to permanently retain the slideable handle onto the solid arm feature.

### BRIEF DESCRIPTION OF THE DRAWINGS

The preferred embodiment of this invention, illustrating all of its features, will now be discussed in detail. This embodiment depicts the novel and non-obvious extendable ratchet of this invention as shown in the accompanying drawings, which are for illustrative purposes only. The drawings include the following figures (FIGS.), with like numerals indicating like parts and lower case letters following numerals indicating features on the numeric components such as teeth, pockets, holes, slots, grooves and/or channels.

FIG. 1 is a top-plan view of the ratchet showing the fixed ⅜ inch driver side and with the slideable handle fully extended.

FIG. 2 is a side view of the ratchet showing the fixed ⅜ inch driver side with the extendable arm at intermediate extension.

FIG. 3 is a cross-section of the ratchet fully extendable and taken along 3-3.

FIG. 4 is a side view showing the ¼ inch driver side extended with the extendable handle fully retracted.

FIG. 5 is a cross section view of the ratchet assembly taken along 5-5 with the extendable handle retracted at intermediate length.

FIG. 6 is a bottom-plan view of the ratchet showing the ¼ inch driver side with extendable handle at intermediate extension.

FIG. 7 is a view of the ratchet gear, pawl, detent ball seat and tension spring in a reverse direction.

FIG. 8 is the same view as FIG. 13 except in the forward direction.

FIG. 9 is a top view of the ratchet body without components.

FIG. 10 is a cross section side view of the ratchet body taken along 10-10.

FIG. 11 is a bottom-plan view of the ratchet body without components.

FIG. 12 is plan view of the slideable release and retainer gate for the ¼ inch driver side.

FIG. 13 is a top view of the ratchet's extendable handle showing the three index holes.

FIG. 14 is cross section view of the extendable handle taken along 14-14.

FIG. 15 is a sectional view of the ratchet head from aft and partial view of the arm taken along 15-15.

FIG. 16 is a cross sectional view of the ratchet head taken along 16-16.

FIG. 17 is a perspective-exploded view of the ratchet's components.

FIG. 17a is a perspective-exploded view of the ratchet's components in solid 3-Dimension.

FIG. 18 is a perspective-elevated view of the ratchet showing the ⅜ inch driver side and extendable handle adjusted to intermediate length.

FIG. 19 is a perspective-elevated view of the ratchet in opposite direction showing the ¼ inch driver end.

FIG. 20 is a perspective-elevated view of the ratchet gear and ⅜ inch driver side showing the guide slot for the ¼ inch driver fully extended.

FIG. 21 is a sectional view of the ratchet gear and ⅜inch driver with the ¼ inch driver side fully retracted and retained by the spring loaded slideable gate lever.

FIG. 22 is a sectional view of the ratchet gear and ⅜ inch driver with the ¼ driver side extended with the spring loaded release gate disengaging the ¼ inch driver.

### A DETAILED DESCRIPTION OF THE PREFERRED EMBODIMENT

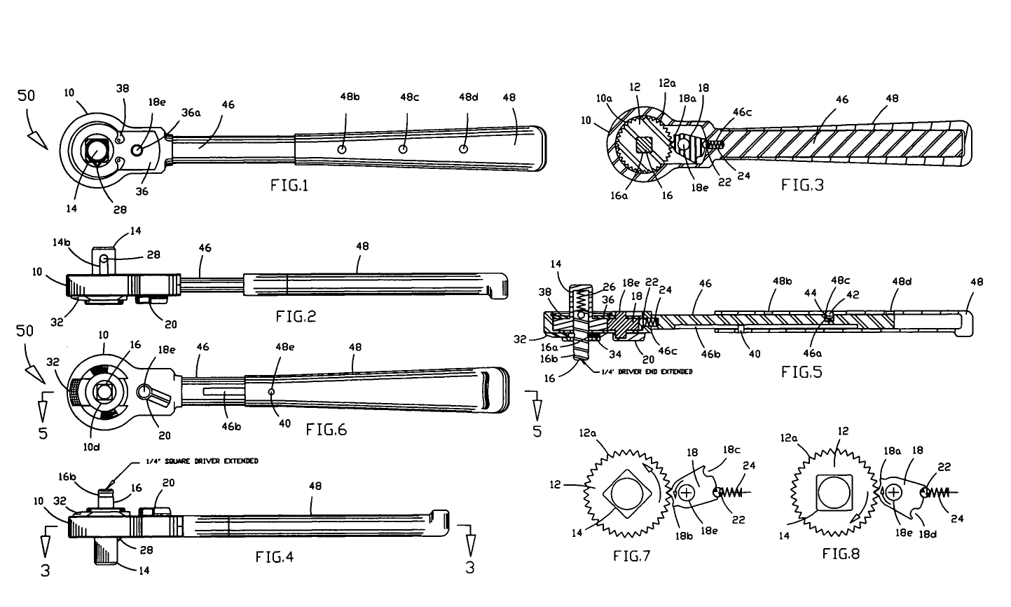

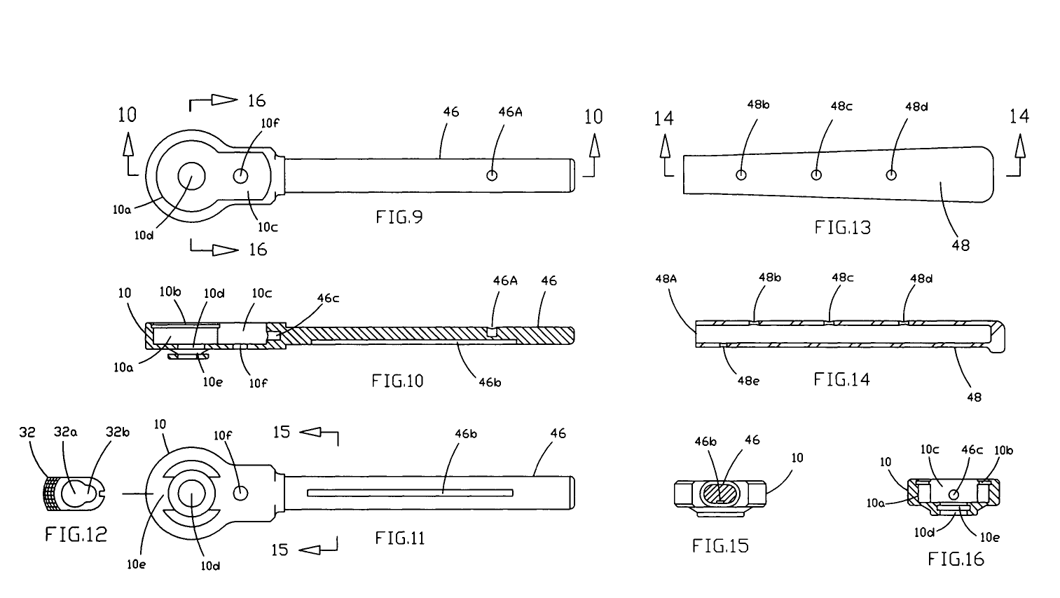

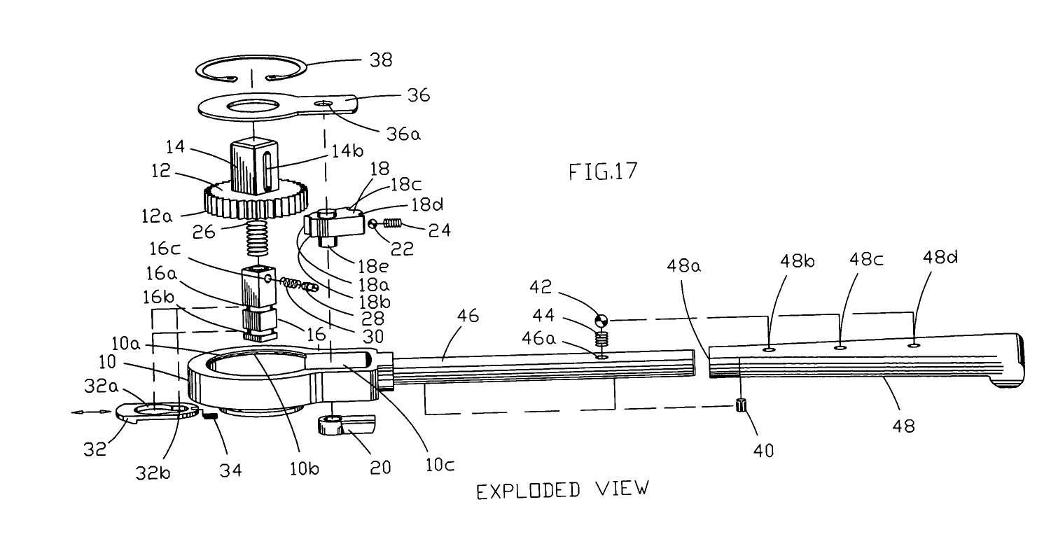

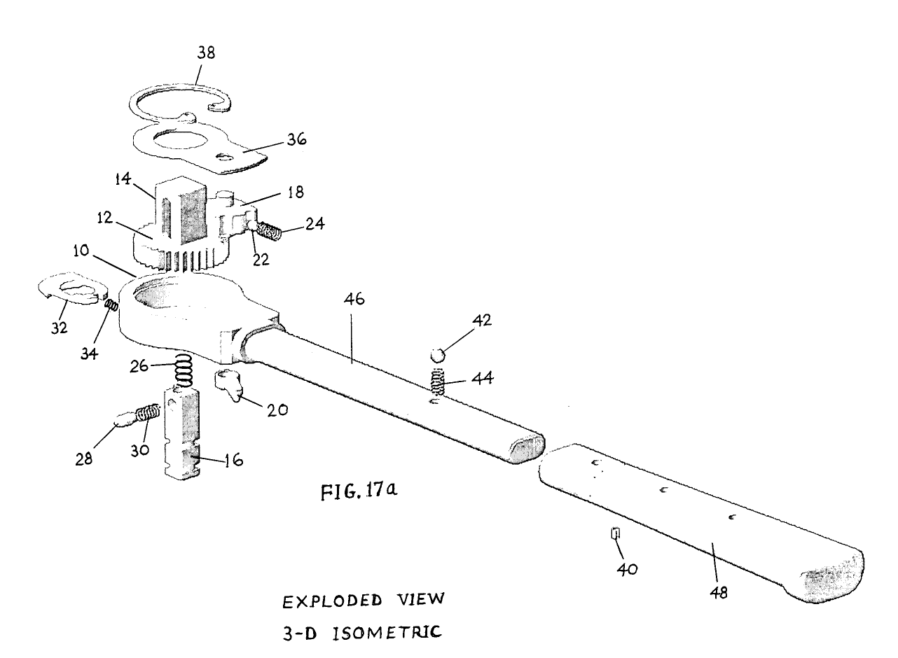

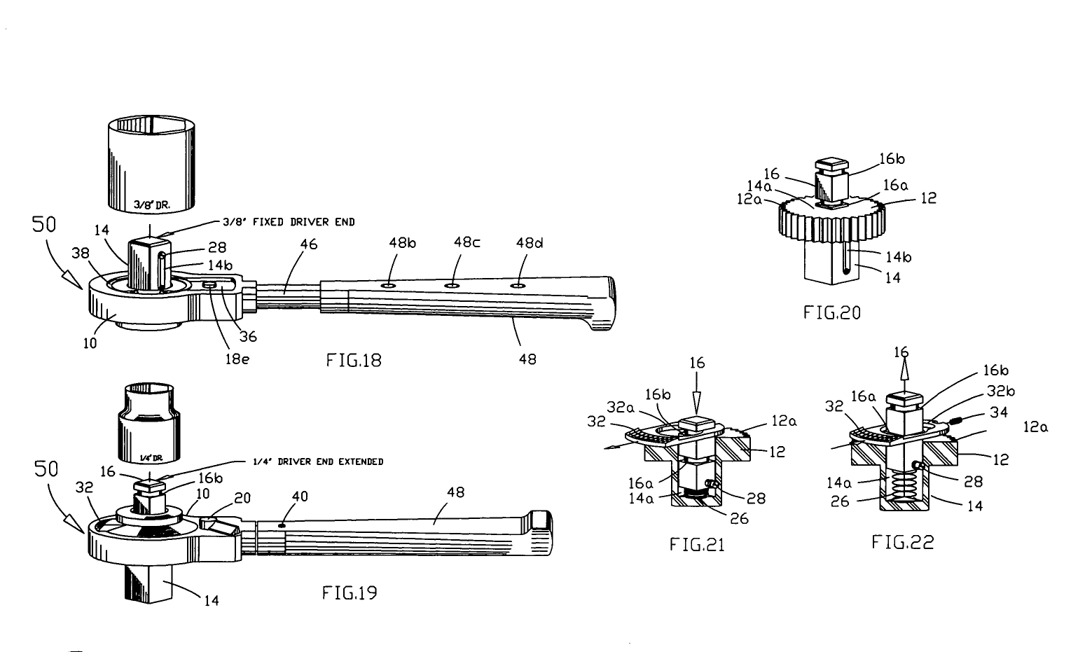

As best shown in FIGS. 1, 2, 3, 4, 5, 6, 7, 8, 12, 17, 17a, 18, 19, 20, 21 and 22 that are relevant to the design and function of this ¼ and ⅜ inch drive extendable ratchet 50 of this invention which includes: a ratchet head 10 with a solid arm 46, serrated ratcheting driver gear 12 that is rotatable about its Z axis and has approximately 36 teeth 12a with a ⅜ inch square driver male plug 14, incorporated as a unit. A square vertical central slot 14a accepts a ¼ inch driver plug 16 having two retaining horizontal grooves 16a and 16b that interlock with the release gate's smaller diameter slot 32b that extends from the central hole diameter 32a of the spring biased release and retention gate 32. When gate 32 is compressed inward, it either releases or extends the ¼ inch driver plug 16 for usage. Gate 32 retains the ¼ inch driver 16 when not in use. A spherical retention pin 28 rides vertically and is permanently retained by guide element slot 14b. The socket retainer detent guide pin 28 protrudes from one side of the ⅜ inch fixed driver side. The tension detent spring 30 is nestled behind the spherical detent retainer pin 28. Both are housed in a horizontal hole 16c located towards the upper end of the ¼ inch driver 16. Spring bias 30 induces constant tension on the spherical guide pin 28 so that it protrudes and rides along the guide element 14b. The guide pin 28 is full radiused and functions as a detent to any of the ⅜ inch drive sockets being used. The sockets are retained during their usage to prevent them from slipping off the ⅜ inch fixed driver end 14. A vertical tension spring 26 is for ejecting the ¼ inch extendable square male driver end 16 to a working protrusion of approximately 5/16 inch. The ratchet driver gear 12 seats within the Z axis of the ratchet head counter bore 10a which is retained by an assembly cover 36. This assembly cover 36 has the same peripheral configuration to that of the ratchet head pockets 10a and 10c of ratchet head 10. The snap-ring 38 is housed within the groove diameter 10b of ratchet head 10 to retain the following ratcheting components: 36, 14/12, 16, 26, 28, 30, 18, 22 & 24. The ratchet driver gear 12a escapes in a rotatable direction that is controlled by the reciprocal manual pivot lever 20, which is connected to the pawl pivot shaft 18e of pawl 18, in either a forward or reverse reciprocal direction. When the user clicks the exterior arm of the pawl reciprocal lever 20 to its left, the driver gear escapes by ratcheting in a clockwise manner. This allows tightening operations in that direction. FIGS. 3, 7 & 8: When the user clicks the left exterior arm 20 of pawl 18e shaft of pawl 18 to its right, this causes the driver gear 12 to escape ratchet in a counterclockwise rotation and this locks the gear teeth 12a of gear 12 in this direction. This function permits ratcheting to effectively be achieved. The ratchet driver gear teeth 12a of gear 12 can be locked in either direction, permitting escape rotation in one direction to either loosen or tighten operations, depending on the right or left reciprocal engagement of pawl teeth 18a or 18b to either pivot forward (to the right) or reverse (to the left). When the reciprocating pawl 18 is clicked in either forward or reverse direction, using exterior lever 20, the tension from spring bias 24 causes pressure on the detent ball 22 to seat into either cam pocket 18c or 18d to secure the pawl 18 embodiment in either the reverse or forward escape direction. The pawl 18e shaft of pawl 18 embodiment pivots vertically within hole 10f of ratchet head 10 and 36a vertical hole of the assembly cover 36 along their axes, and parallel to that of the central Z axis of ratchet head 10. The pawl lever 20 is vertically located on the underside and aft of the ¼ driver plug 16. The two serrated teeth 18a and 18b of the pawl 18 embodiment are spaced 45 degrees radially apart and interlock with the serrated teeth 12a of ratchet gear 12 in one direction (approximately 22.50 degrees). Escape ratcheting in the other direction is functionally permissible. The ratcheting teeth 18a and 18b are radially aligned with that of the cam pockets 18c and 18d of pawl 18 embodiment. The pawl 18 embodiment pivots to a reciprocity (approximately 22.5 degrees) in either direction and vertically within pocket 10c of socket head 10. The detent ball 22 which is tension induced within either of the pawl pockets 18c and 18d of pawl 18 embodiment, the tension spring 24 and detent ball 22 are housed in a horizontal hole 46c. Hole 46c is parallel to and on the Y axis of the ratchet arm 46 of ratchet embodiment 50. The ¼ inch driver end 16 is either retractable or extendable. The ¼ inch driver end 16 may either be retained or released by the ¼ inch driver release gate 32, with the aid of its spring bias companion 34. When the release gate 32 embodiment is compressed inward, the ¼ inch extendable driver end 16 is released outward through the central hole 32a within embodiment 32 (Ref. FIG. 12). When release gate 32 embodiment is not compressed inward, the smaller connecting radiused slot 32b interlocks with either lower neck groove 16a when retracted or upper neck groove 16b when extended for usage of the ¼ inch driver 16 (Ref. FIGS. 17, 21 and 22). The counter bore 10a feature is concentric within ratchet head 10 which houses the ratchet gear 12. The smaller diameter counter-bore 10d is also concentric to that of counter bore 10a of ratchet head 10. This allows access for the ¼ inch slideable driver plug 16 which rides within the vertical slot 14a of the ⅜ inch fixed driver plug 14. As the user compresses the release and retention gate 32 embodiment inwards, spring tension is induced on the interior end of ¼ inch driver 16 so that it is expelled outward and in an adequately protruding length for usage on standard ¼ drive sockets (Ref. FIG. 19 and FIG. 22). The extendable handle 48 is composed of a hollow structure 48a and slides onto the solid arm 46 of ratchet embodiment 50. The extendable handle 48 embodiment has a drilled vertical hole 48e at its underside to retain retention spring pin 40. The retention spring pin 40 is press fitted into the vertical hole 48e (Ref. FIG. 14), of the extendable handle 48 embodiment to permanently retain itself to the solid arm 46 of ratchet embodiment 50. The spring pin 40 rides within a channel 46b located on the underside and parallel to the longitudinal axis of the solid arm 46. Channel 46b has an approximate length of 3.00 inches (Ref. FIG. 11). The length of channel 46b reflects the maximum longitudinal distance the extendable handle 48 embodiment is capable of traveling. The ratchet arm 46 of the ratchet embodiment 50 has a vertical hole 46a to a depth to allow detent tension spring 44 and detent ball 42 to nest within the hole 46a (Ref. FIG. 5). The extendable handle embodiment 48 has three vertical holes 48b, 48c, and 48d located at its top side. As the slideable handle embodiment 48 is being extended along the longitudinal axis of the solid arm 46, the tension from the spring bias 44 induced on the steel detent ball 42 nestled within the hole 46a of solid arm 46 catches and seats into the interior side of holes 48b, 48c or 48d, depending upon the length requirement. The extendable handle embodiment 48 is thus permanently retained onto the ratchet embodiment 50 at either 5.00 inches when fully retracted, 6.00 inches intermediate or 7.00 inches fully extended.

### SCOPE OF THE INVENTION

The above represents a description of the best mode contemplated of carrying out the present invention, and of the manner and process of its manufacture and utilization in such full, clear, concise and exact terms as to enable any person skilled in the art to which it pertains to produce and use this invention. This invention is, however, susceptible to modifications and alternate constructions from that discussed above which are fully equivalent. Consequently, it is not the intention to limit this invention to the particular embodiment disclosed. On the contrary, the intention is to cover all modifications and alternate constructions coming within the spirit and scope of the invention as generally expressed by the following claims, which particularly point out and distinctly claim the subject matter of this invention:

What I claim as my invention is:

1. An all-in-one combination ¼ inch/⅜ inch drive multi ratchet that eliminates the need for an individual ¼ inch drive and an individual ⅜ inch drive ratchet. The user simply compresses the ratchet's release gate inwards to release and expose the smaller ¼ inch slideable square male driver for use on a plurality of ¼ inch drive standard sockets. The ¼ inch square male driver plug functions vertically within the ¼ inch square female slot located at the central axis of the ⅜ inch fixed driver and ratcheting gear unit. The vertical operating distance of the ¼ inch square driver is approximately 5/16 of an inch and extends to the corresponding protrusion to adequately accept any range of standard ¼ inch square drive sockets.

2. A fixed ⅜ inch square driver comprised of a vertical guide slot on one side to accept a spherical side retention guide pin. The spherical guide pin rides within the vertical length of the guide slot to permanently retain the ¼ inch slideable square male driver. The ⅜ inch fixed driver and ratcheting gear is of a one piece construction. The square ¼ inch female slot is located at the central axis to the ratchet gear and fixed ⅜ inch square driver embodiment. The central interior axis of the 0.255 square female slot sufficiently accepts a standard size 0.250 male square driver plug. The ¼ inch square driver male plug has a horizontal hole to accept a spring bias that induces constant tension on the spherical guide pin which seats in front of the spring bias. The spherical guide pin permanently retains the ¼ inch square driver when either retracted or extended. The spherical guide pin also functions as a detent when using the larger and standard size range of ⅜ inch drive sockets.

3. A ¼ inch square driver that functions independently from that of the larger and fixed ⅜ inch driver side and ratcheting gear embodiment. An extendable ¼ inch male driver end that can either be retracted when not in use for ease of stowage, or expelled with the aid of an opposing spring bias. This occurs when the user compresses the knurled feature on the underside of the ratchet head embodiment to compress the release gate inwards when the ¼ inch driver is needed. The ¼ inch driver has two grooves or neck features: an upper groove for retaining the ¼ inch driver end when retracted and a lower groove for securing the ¼ inch driver end when extended for usage. This is accomplished with the aid of the slideable function release and retaining gate embodiment that is located with a spring bias at its opposing end for releasing and retaining the ¼ inch extendable driver end when extended for use or retracted when not in use.

4. A spring biased release and retention gate mechanism that releases the extendable ¼ inch square male driver and retains it when retracted for non usage. The release and retention gate is a flat piece of sheet metal construction, preferably a steel stamping with a knurled exterior, non slip, surface for compressing in an inward direction. The release and retention gate embodiment has a central hole that has a diameter sufficient enough to release (clear) the spring induced ¼ inch male driver end an adequate working length. The larger or central hole of the release and retention gate has a smaller and elongated diameter slot extending from its larger central hole to sufficiently retain the ¼ inch driver side at either of its two selected neck grooved diameters. The first or upper neck groove retains the ¼ inch driver in the retracted position while the bottom neck groove retains the ¼ inch driver in the extended, or working position for safe usage.

5. A ratcheting pawl that is the same thickness as its mating ratcheting gear for increased torque capability. The ratcheting pawl is of a one piece construction that includes its pivoting shaft for higher torque capability. More commonly manufactured in a two piece construction, the ratcheting pawl herein has two ratcheting teeth that are spaced approximately 45 degrees apart so that the ratcheting pawl can effectively and most efficiently operate in its narrowed designed ratchet head pocket of this preferred embodiment. This narrow configured ratcheting pawl rests solidly against the right or left wall of the ratchet head pocket. The ratcheting pawl operates in a reciprocal motion to approximately 45 degrees from right to left or vise versa. The lower shaft portion of the ratcheting pawl embodiment protrudes sufficiently at the ratchet body's underside to be able to accept a press fitted reciprocal forward and reverse exterior lever. The ratcheting pawl exterior lever has a non-slip knurl thumb feature that can be operated with a high degree of efficiency, even when it is subjected to oils and/or grease.

6. An extendable handle to provide a plurality of leverage for multiple torque requirements for either the smaller ¼ inch drive sockets for lower torque requirements, or the larger ⅜ inch drive sockets for higher torque requirements. The user pulls out the extendable handle which, at 5.00 inches, is fully retracted. The handle's intermediate extension occurs at 6.00 inches in length and its full extension occurs at 7.00 inches in length for maximum torque requirements. The exterior, slideable, hollow arm handle rides horizontally over the Y longitudinal axis of the solid arm portion of the ratchet embodiment. Each adjusted length is secured by a tension induced detent ball, located on the solid arm feature. The detent ball seats into the interior side of any of the three equally spaced holes provided on the slideable handle embodiment. The extendable handle is guided by a roll type pin that rides within a slotted channel running longitudinally along the Y axis of the ratchet's solid arm for permanently securing the extendable handle. The width of the extendable handle is tapered or flared outwardly to aid the user in effectively gripping the extendable the handle to any of the three desired settings for wrenching in a safe manner. When the ratchet is not in use, the extendable handle can be fully retracted to its minimum (5.00 inches) length for compactness and ease of storage.

7. The ratchet wrench has an ultra thin profile. This is an asset when working in close places where a particular working condition may be a limitation for a conventional ⅜ inch drive ratchet, which has a thicker and longer configuration. The ratcheting gear of this invention is considerably thinner than the conventional ratcheting gears of a similar configuration without the loss of structural integrity. As a result of the slimmer ratcheting gear, the entire ratchet wrench embodiment has an ultra-thin profile. The preferred embodiment of this invention is less than 0.500 inches in overall thickness when the ¼ inch driver end is retracted. The neck and extendable handle portions of the ratchet embodiment have an average thickness of approximately 0.350/0.360 inches. The entire ratchet wrench embodiment is significantly lighter than a conventional ratchet wrench that has a similar configuration and application.
